(19) United States
(12) Patent Application Publication
(10) Pub. No.: US 2018/0308253 A1
(43) Pub. Date: Oct. 25, 2018

(54) METHOD AND SYSTEM FOR TIME ALIGNMENT CALIBRATION, EVENT ANNOTATION AND/OR DATABASE GENERATION

(71) Applicants: SAMSUNG ELECTRONICS CO., LTD., Suwon-si (KR); BEIJING SAMSUNG TELECOM R&D CENTER, Beijing (CN)

(72) Inventors: Hyun Surk RYU, Hwaseong-si (KR); Joo Yeon WOO, Hwaseong-si (KR); Keun Joo PARK, Seoul (KR); Hyun Ku LEE, Suwon-si (KR); Wei Heng LIU, Beijing (CN); Dong Qing ZOU, Beijing (CN); Feng SHI, Beijing (CN); Jia LI, Beijing (CN); Qiang WANG, Beijing (CN)

(21) Appl. No.: 15/665,222

(22) Filed: Jul. 31, 2017

(30) Foreign Application Priority Data
Apr. 25, 2017 (CN) 201710278061.8

(51) Int. Cl. G06T 7/80; G06T 7/246; G06T 7/292; G06K 9/00; G06K 9/78; G06K 9/20; H04N 5/04

(52) U.S. Cl. CPC G06T 7/80; G06T 7/248; G06T 7/292; G06K 9/00711; G06T 2207/10028; G06K 9/209; H04N 5/04; G06T 2207/10016; G06K 2009/00738; G06K 9/78

(57) ABSTRACT

Methods and apparatuses for time alignment calibration are provided including acquiring an event-stream and video images of a target object which are simultaneously shot by a dynamic vision sensor and an assistant vision sensor, determining a key frame that reflects obvious movement of the target object from the video images, mapping effective pixel positions of the target object in the key frame and effective pixel positions of the target object in the neighboring frames according to a spatial relative relation between the dynamic vision sensor and the assistant vision sensor, determining a first target object template that covers events in a first event-stream segment from the plurality of target object templates, and using a time alignment relation of an intermediate instant of the first event-stream segment and a timestamp of a frame corresponding to the first target object template between the dynamic vision sensor and the assistant vision sensor.

### PRIORITY CLAIM

This application claims priority under 35 U.S.C. §119 to Chinese Patent Application No. 201710278061.8, filed on Apr. 25, 2017, in the State Intellectual Property Office, the disclosure of which is incorporated by reference in its entirety

### TECHNICAL FIELD

The present invention generally relates to dynamic vision sensor (DVS), more particularly to a time alignment calibration method and apparatus, an event annotation method and apparatus and a database generation method and apparatus.

### BACKGROUND

Unlike the typical frame-based vision sensor, DVS is a temporal continuous imaging vision sensor, and its temporal resolution can reach 1 us. DVS outputs a series of events, including horizontal coordinates, vertical coordinates, polarity, and timestamp of the events on an imaging plane. DVS is also a differential imaging sensor, which is responsive to light changes. Thus, energy consumption of the DVS is lower than a common sensor, but its light sensitivity is higher than the common vision sensor. Based on the above characteristic, DVS may solve problems that cannot be resolved by the typical vision sensor and brings new challenges.

Different vision sensors have relative position and relative time derivations therebetween, and the derivations may destroy the assumption of time space consistency of a multi-vision sensor system. Therefore, spatial-temporal calibration among the multi-vision sensors is a basis for analyzing and fusing signals of different vision sensors.

### SUMMARY

Various embodiments described herein provide methods, apparatus, and systems for time alignment calibration, event annotation and database generation, capable of implementing time alignment calibration between a dynamic vision sensor and a vision sensor based on an image frame, labeling events in an event-stream output by the dynamic vision sensor, and generating a database for serving the dynamic vision sensor.

According to an some embodiments of the present invention, a time alignment calibration method includes acquiring an event-stream and video images of a target object which are simultaneously shot by a dynamic vision sensor and an assistant vision sensor, respectively, determining a key frame that reflects obvious movement of the target object from the video images, mapping effective pixel positions of the target object in the key frame and effective pixel positions of the target object in the neighboring frames of the key frame respectively to an imaging plane of the dynamic vision sensor according to a spatial relative relation between the dynamic vision sensor and the assistant vision sensor, to form a plurality of target object templates, determining a first target object template that covers the most events in a first event-stream segment from the plurality of target object templates. The first event-stream segment may be an event-stream segment having a predetermined time length in the vicinity of a timestamp of the key frame in the event-stream and mapped along time axis, and using a time alignment relation of an intermediate instant of the first event-stream segment and the timestamp of a frame corresponding to the first target object template as a time alignment relation between the dynamic vision sensor and the assistant vision sensor.

In some embodiments, the method may include, after determining the first target object template, predicting target object templates formed by mapping effective pixel positions of the target object in frames generated by the assistant vision sensor in time points adjacent to the timestamp of the frame corresponding to the first target object template to the imaging plane of the dynamic vision sensor according to the spatial relative relation between the dynamic vision sensor and the assistant vision sensor, determining a second target object template that covers the most events in the first event-stream segment from predicted target object templates and the first target template, and updating the first target object template using the determined second target object template. In some embodiments, after determining the first target object template, determining a second event-stream segment in which the most events are covered by the first target object template from a plurality of event-stream segments having predetermined time length and adjacent to the first event-stream segment and the first event-stream segment, and updating the first event segment using the determined second event-stream segment.

In some embodiments, the time points adjacent to the timestamp of the frame corresponding to the first target object template comprises: time points of predetermined time intervals between the timestamp of the frame corresponding to the first target object template and a timestamp of a previous frame, and/or time points of predetermined time intervals between the timestamp of the frame corresponding to the first target object template and a timestamp of a next frame.

In some embodiments, the second target object template is determined based on the first target object and the first event-stream segment based on a temporal meanshift algorithm.

In some embodiments, the predetermined time length is less than or equal to the time intervals between adjacent frames of the video images, and the time alignment calibration method may include mapping, along the time axis, an event-stream segment having a predetermined time length and using the timestamp of the key frame as the intermediate instant in the event-stream, as the first event-stream segment, or determining a shooting time point of alignment of the dynamic vision sensor and the timestamp of the key frame according to an initial time alignment relation between the dynamic vision sensor and the assistant vision sensor. The method may include mapping, along the time axis, an event-stream segment having predetermined time length and using the shooting time point of the alignment as the intermediate instant in the event-stream, as the first event-stream segment.

In some embodiments, the effective pixel positions of the target object are pixel positions occupied by the target object in a frame, or pixel positions occupied by outwardly extending the pixel positions occupied by the target object in the frame by a predetermined range.

In some embodiments, determining a first target object template may include determining a number of events in the first event-stream segment corresponding to the pixel positions covered by each of the plurality of target object templates in the imaging plane, and determining a target object template corresponding to the largest number of events as the first target object template, or projecting the events in the first event-stream segment to the imaging plane by time integral to obtain projection position. The method may include determining pixel positions, covered by each of the plurality of target object templates, in the imaging plane, and determining a target object template of which the covered pixel positions overlap the most projection position, as the first target object template.

In some embodiments, the assistant vision sensor may be a depth vision sensor, and the video images may be depth images.

In some embodiments, a lens of the dynamic vision sensor may be adhered with a filter to remove influence on shooting of the dynamic vision sensor when shooting the target object with the assistant vision sensor simultaneously.

In some embodiments, the spatial relative relation between the dynamic vision sensor and the assistant vision sensor may be calibrated according to intrinsic and extrinsic parameters of the dynamic vision sensor as well as intrinsic and extrinsic parameters of the assistant vision sensor.

According to some embodiments of the present invention, an event annotation method may be provided that includes calibrating a time alignment relation between the dynamic vision sensor and the assistant vision sensor by the above time alignment calibration method, acquiring an event-stream and video images of a object to-be-labeled which are simultaneously shot by the dynamic vision sensor and the assistant vision sensor, respectively, acquiring effective pixel positions of the object to-be-labeled and label data of each of the effective pixel positions, for each frame of the video images of the object to-be-labeled, and mapping the effective pixel positions and label data to the imaging plane of the dynamic vision sensor according to the spatial relative relation between the dynamic vision sensor and the assistant vision sensor, to form a label template corresponding to each frame, and labeling events corresponding to the label template in the event-stream of the object to-be-labeled, according to the corresponding label template. An event corresponding to the label template is the event of which a timestamp may be overlapped by a time period of a label template, and a pixel position may be overlapped by the label template. The time period of the label template may be a time period in the vicinity of a time point where the timestamp of the frame corresponding to the label template aligned according to the time alignment relation between the dynamic vision sensor and the assistant vision sensor.

In some embodiments, labeling an event according to the label template may include labeling the event according to the label data having the same pixel position with the event in the label template.

In some embodiments, the time period of the label template may be a time period having a predetermined time length and using the time point where the timestamps of the frame corresponding to the label template is aligned according to the time alignment relation between the dynamic vision sensor and the assistant vision sensor as the intermediate instant.

In some embodiments, when the predetermined time length is shorter than a time interval between the adjacent frames of the video images, the determining the first target object template may include, with regard to the event of which the timestamp is not overlapped by the time period of any label templates in the event-stream of the object to-be-labeled, using a temporal nearest neighbor algorithm to determine the corresponding label template, and labeling the event according to the corresponding label template.

In some embodiments, mapping effective pixel positions may include predicting label templates formed by mapping the effective pixel positions of the object to-be-labeled in frames generated by the assistant vision sensor in each time point between each two adjacent frames of the video images and the label data of the effective pixel positions to the imaging plane of the dynamic vision sensor according to the spatial relative relation between the dynamic vision sensor and the assistant vision sensor.

According to some embodiments of the present invention, a database generation method is provided, which includes labeling the events in the event-stream of the shot object to-be-labeled by the above event annotation method, and storing the labeled event-stream to form a database for serving the dynamic vision sensor.

According to some embodiments of the present invention, there provides a time alignment calibration apparatus, including an acquisition unit to acquire an event-stream and video images of a target object which are simultaneously shot by a dynamic vision sensor and an assistant vision sensor, respectively. A key frame determination unit may be included to determine a key frame that reflects obvious movement of the target object from the video images. A template forming unit may be included to map effective pixel positions of the target object in the key frame and effective pixel positions of the target object in the neighboring frames of the key frame respectively to an imaging plane of the dynamic vision sensor according to a spatial relative relation between the dynamic vision sensor and the assistant vision sensor, to form a plurality of target object templates. A determination unit may determine a first target object template that covers the most events in a first event-stream segment from the plurality of target object templates, wherein the first event-stream segment is an event-stream segment having a predetermined time length in the vicinity of a timestamp of the key frame in the event-stream and mapped along time axis. A calibration unit may use a time alignment relation of an intermediate instant of the first event-stream segment and the timestamp of a frame corresponding to the first target object template as a time alignment relation between the dynamic vision sensor and the assistant vision sensor.

In some embodiments, the determination unit, after determining the first target object template, may predict target object templates formed by mapping effective pixel positions of the target object in frames generated by the assistant vision sensor in time points adjacent to the timestamp of the frame corresponding to the first target object template to the imaging plane of the dynamic vision sensor according to the spatial relative relation between the dynamic vision sensor and the assistant vision sensor, determines a second target object template that covers the most events in the first event-stream segment from predicted target object templates and the first target template, and updates the first target object template using the determined second target object template, or the determination unit, after determining the first target object template, determines a second event-stream segment in which the most events are covered by the first target object template from a plurality of event-stream segments having predetermined time length and adjacent to the first event-stream segment and the first event-stream segment, and updates the first event segment using the determined second event-stream segment.

In some embodiments, the time points adjacent to the timestamp of the frame corresponding to the first target object template comprises: time points of predetermined time intervals between the timestamp of the frame corresponding to the first target object template and a timestamp of a previous frame, and/or time points of predetermined time intervals between the timestamp of the frame corresponding to the first target object template and a timestamp of a next frame.

In some embodiments, the determination unit determines the second target object template based on the first target object and the first event-stream segment by means of a temporal meanshift algorithm.

In some embodiments, the predetermined time length is less than or equal to the time intervals between adjacent frames of the video images, wherein the time alignment calibration apparatus further comprises: an event-stream segment acquisition unit to map, along the time axis, an event-stream segment having a predetermined time length and using the timestamp of the key frame as the intermediate instant in the event-stream, as the first event-stream segment, or determine a shooting time point of alignment of the dynamic vision sensor and the timestamp of the key frame according to an initial time alignment relation between the dynamic vision sensor and the assistant vision sensor; and map, along the time axis, an event-stream segment having predetermined time length and taking the shooting time point of the alignment as the intermediate instant in the event-stream, as the first event-stream segment.

In some embodiments, the effective pixel positions of the target object are pixel positions occupied by the target object in a frame, or pixel positions occupied by outwardly extending the pixel positions occupied by the target object in the frame by a predetermined range.

In some embodiments, the determination unit determines a number of events in the first event-stream segment corresponding to the pixel positions covered by each of the plurality of target object templates in the imaging plane, and determines a target object template corresponding to the largest number of events as the first target object template, or the determination unit projects the events in the first event-stream segment to the imaging plane by time integral to obtain projection position; determines pixel positions, covered by each of the plurality of target object templates, in the imaging plane, and determines a target object template of which the covered pixel positions overlap the most projection position, as the first target object template.

In some embodiments, the assistant vision sensor is a depth vision sensor, and the video images are depth images.

In some embodiments, a lens of the dynamic vision sensor is adhered with a filter to remove influence on shooting of the dynamic vision sensor when shooting the target object with the assistant vision sensor simultaneously.

In some embodiments, the spatial relative relation between the dynamic vision sensor and the assistant vision sensor is calibrated according to intrinsic and extrinsic parameters of the dynamic vision sensor as well as intrinsic and extrinsic parameters of the assistant vision sensor.

According to embodiments of the present invention, there provides an event annotation apparatus, comprising: the above time alignment calibration apparatus to calibrate a time alignment relation between the dynamic vision sensor and the assistant vision sensor; an acquisition unit to acquire an event-stream and video images of a object to-be-labeled which are simultaneously shot by the dynamic vision sensor and the assistant vision sensor, respectively; a template forming unit to acquire effective pixel positions of the object to-be-labeled and label data of each of the effective pixel positions, for each frame of the video images of the object to-be-labeled, and map the effective pixel positions and label data to the imaging plane of the dynamic vision sensor according to the spatial relative relation between the dynamic vision sensor and the assistant vision sensor, to form a label template corresponding to each frame; and a labeling unit to label events corresponding to the label template in the event-stream of the object to-be-labeled, according to the corresponding label template, wherein an event corresponding to the label template is the event of which a timestamp is overlapped by a time period of a label template, and a pixel position is overlapped by the label template, wherein the time period of the label template is a time period in the vicinity of a time point where the timestamp of the frame corresponding to the label template aligned according to the time alignment relation between the dynamic vision sensor and the assistant vision sensor.

In some embodiments, the labeling unit labels an event according to the label data having the same pixel position with the event in the label template.

In some embodiments, the time period of the label template is a time period having a predetermined time length and using the time point where the timestamps of the frame corresponding to the label template is aligned according to the time alignment relation between the dynamic vision sensor and the assistant vision sensor as the intermediate instant.

In some embodiments, when the predetermined time length is shorter than a time interval between the adjacent frames of the video images, with regard to the event of which the timestamp is not overlapped by the time period of any label templates in the event-stream of the object to-be-labeled, the labeling unit uses a temporal nearest neighbor algorithm to determine the corresponding label template, and labels the event according to the corresponding label template.

In some embodiments, the template forming unit further predicts label templates formed by mapping the effective pixel positions of the object to-be-labeled in frames generated by the assistant vision sensor in each time point between each two adjacent frames of the video images and the label data of the effective pixel positions to the imaging plane of the dynamic vision sensor according to the spatial relative relation between the dynamic vision sensor and the assistant vision sensor.

According to some embodiments of the present invention, there provides a data generation apparatus, including the above event annotation apparatus to label the events in the event-stream of the shot object to-be-labeled, and a storage unit to store the labeled event-stream to form a database for serving the dynamic vision sensor.

The method and system for time alignment calibration, event annotation and database generation according to some embodiments of the present invention capable of implementing time alignment calibration between a dynamic vision sensor and a vision sensor based on an image frame, labeling events in an event-stream output by the dynamic vision sensor, and generating a database serving for the dynamic vision sensor.

According to some embodiments, a method of operating Dynamic Vision Sensors (DVS) in a multi-view video system includes acquiring a first video event-stream of a target object from a dynamic vision sensor, acquiring a second video event-stream of the target object from an assistant vision sensor, recognizing movement of the target object in a key frame of the first video event-stream of the target object from the dynamic vision sensor, determining a synchronized frame from the assistant vision sensor based on a mapping of effective pixel positions of the target object in the key frame to pixel positions in one or more frames in the second video event-stream of the target object from an assistant vision sensor, and generating labeling of a DVS image sequence based on interpolating frames associated with the synchronized frame between the first video event-stream from the dynamic vision sensor and the second video event-stream from the assistant vision sensor based on the synchronized frame.

Other aspects of the general conception and/or advantages of the present invention will be partially illustrated in the following description, and other aspects will be clarified through further description or implementation of the general conception of the present invention.

It is noted that aspects of the inventive concepts described with respect to one embodiment, may be incorporated in a different embodiment although not specifically described relative thereto. That is, all embodiments and/or features of any embodiment can be combined in any way and/or combination. These and other aspects of the inventive concepts are described in detail in the specification set forth below.

### BRIEF DESCRIPTION OF THE DRAWINGS

The above and other targets and characteristics of embodiments of the present invention will become apparent from the following description, taken in conjunction with the accompanying drawings in which:

FIG. 1 is a flowchart of a time alignment calibration method according to embodiments of the present invention;

FIGS. 2A to 2F are examples of determining a first target object template according to embodiments of the present invention;

FIG. 3 is a flowchart of a time alignment calibration method according to embodiments of the present invention;

FIG. 4 is a flowchart of a time alignment calibration method according to embodiments of the present invention;

FIGS. 5A to 5B illustrate an example of determining a second target object template according to embodiments of the present invention;

FIGS. 6A to 6B illustrate effects of covering events by the second target object template over the first target object template according to embodiments of the present invention;

FIGS. 7A to 7B illustrate effects of covering events by the second target object template over the first target object template according to embodiments of the present invention;

FIG. 8 is a flowchart of an event annotation method according to embodiments of the present invention;

FIG. 9 is a flowchart of a database generation method according to embodiments of the present invention;

FIG. 10 is a flowchart of a time alignment calibration apparatus according to embodiments of the present invention;

FIG. 11 is a flowchart of an event annotation apparatus according to embodiments of the present invention; and

FIG. 12 is a flowchart of a database generation apparatus according to embodiments of the present invention.

### DETAILED DESCRIPTION

Here a detailed reference will be made with respect to embodiments shown in the drawings, where the same reference signs may refer to the same component all along. Embodiments of the present disclosure will be described in detail below by referring to the accompany drawings.

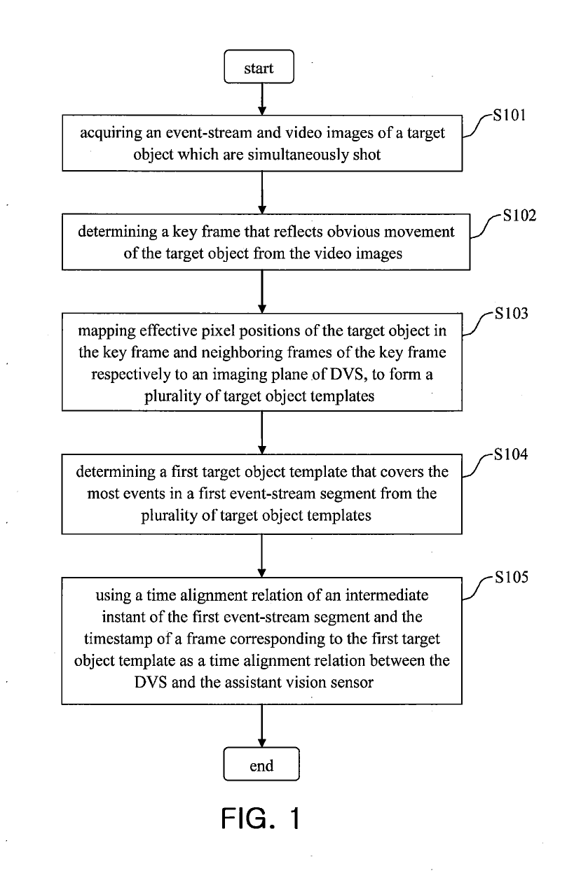

FIG. 1 is a flowchart of a time alignment calibration method according to embodiments of the present invention.

Referring to FIG. 1, at a block S101, an event-stream and video images of a target object which are simultaneously shot by a dynamic vision sensor and an assistant vision sensor are acquired. The dynamic vision sensor and the assistant vision sensor are used simultaneously to shoot the target object, to acquire the event-stream shot by the dynamic vision sensor and the video images shot by the assistant vision sensor.

The assistant vision sensor may be of various types of vision sensors based on an image frame. For example, the assistant vision sensor may be a depth vision sensor, and the video images shot by the assistant vision sensor may be depth images.

Further, as an additional example, a lens of the dynamic vision sensor may be associated with a filter to remove influence on shooting of the dynamic vision sensor when shooting the target object with the assistant vision sensor simultaneously. Association of the filter to the lens may be accomplished by attaching, adhering, or placing in close proximity the filter to the lens. Association of the filter may further include digitally processing data obtained at the lens to remove the influence of the dynamic vision sensor when shooting with the assistant vision sensor. For example, if an infrared emitter of the assistant vision sensor has an effect on imaging quality of the dynamic vision sensor while shooting the target object, an infrared filter will be adhered to the lens of the dynamic vision sensor.

At block S102, a key frame that reflects obvious movement of the target object is determined from the video images.

Various methods may be applied to determine a key frame that reflects obvious movement of the target object in the video images. As an example, a motion state of the target object in each frame may be determined based on the video images (for example, a location of the target object in each frame), and then the key frame that reflects obvious movement of the target object may be determined.

As an example, the key frame that reflects obvious movement of the target object in the video images may be acquired from the assistant vision sensor (that is, determining the key frame may be performed by the assistant vision sensor), and then the key frame that reflects obvious movement of the target object may be determined from the video images. A motion state of the target object in the video images may be acquired from the assistant vision sensor (that is, the assistant vision sensor may detect the motion state of the target object in the video images), and then the key frame that reflects obvious movement of the target object may be determined based on the acquired motion state of the target object in the video images. For example, when the assistant vision sensor is a depth vision sensor, it may calculate the motion state of the target object in the video images based on the shot depth images of the target object.

At block S103, effective pixel positions of the target object in the key frame and effective pixel positions of the target object in the neighboring frames of the key frame are mapped to an imaging plane of the dynamic vision sensor, respectively, according to the spatial relative relation between the dynamic vision sensor and the assistant vision sensor, to form a plurality of target object templates.

Each target object template corresponds to a frame, and pixel positions in the imaging plane covered by each target object template includes pixel positions corresponding to the effective pixel positions in the corresponding frame, generated by mapping the effective pixel positions to the imaging plane of the dynamic vision sensor.

As an example, the effective pixel positions of the target object may be pixel positions occupied by the target object in a frame. As an another example, the effective pixel positions of the target object may be pixel positions occupied by outwardly extending the pixel positions in the frame occupied by the target object by a predetermined range. The effective pixel positions of the target object in each frame may be detected by proper algorithms, and may also be acquired from the assistant vision sensor. In other words, the assistant vision sensor may detect the effective pixel positions of the target object in each frame.

As an example, the neighboring frames of the key frame may be a first predetermined quantity of frames preceding the key frame and/or a second predetermined quantity of frames following the key frame, where the first predetermined quantity and the second predetermined quantity may be the same or not.

As an example, the spatial relative relation between the dynamic vision sensor and the assistant vision sensor may be calibrated based on the intrinsic and extrinsic parameters of the dynamic vision sensor as well as the intrinsic and extrinsic parameters of the assistant vision sensor. For instance, the spatial relative relation between the dynamic vision sensor and the assistant vision sensor may be calibrate by Zhang's camera calibration method and other proper calibration manners.

At block S104, a first target object template that covers the most events in a first event-stream segment is determined from the plurality of target object templates. The first event-stream segment may be an event-stream segment having a predetermined time length in the vicinity of the timestamp of the key frame in the event-stream and mapped along the time axis. As an example, the predetermined time length may be less than or equal to the time intervals between adjacent frames of the video images.

In some embodiments, an event-stream segment having a predetermined time length and using the timestamp of the key frame as the intermediate instant in the event-stream, mapped along the time axis, serves as the first event-stream segment. As an another example, a shooting time point of alignment of the dynamic vision sensor and the timestamp of the key frame may be determined according to an initial time alignment relation between the dynamic vision sensor and the assistant vision sensor. (that is, an initial value of the time alignment relation between the dynamic vision sensor and the assistant vision sensor). An event-stream segment having predetermined time length and using the shooting time point of the alignment as the intermediate instant in the event-stream, mapped along the time axis may serve as the first event-stream segment.

As an example, a number of events in the first event-stream segment corresponding to the pixel positions covered by each of the plurality of target object templates in the imaging plane may be determined first, and then a target object template corresponding to the largest number of events may be determined as the first target object template. Specifically, each event may correspond to a pixel position on the imaging plane of the dynamic vision sensor, and the pixel positions in the imaging plane covered by each target object template may include pixel positions corresponding to the effective pixel positions in the corresponding frame, generated by mapping the effective pixel positions to the imaging plane of the dynamic vision sensor, thereby determining the number of the events in the first event-stream segment corresponding to the pixel position covered by each of the plurality target object template in the imaging plane.

As an another example, the events in the first event-stream segment may be projected to the imaging plane by time integral to obtain projection position. Then, pixel positions, covered by each of the plurality of target object templates in the imaging plane may be determined. A target object template of which the covered pixel positions overlap the most projection position, may be determined as the first target object template.

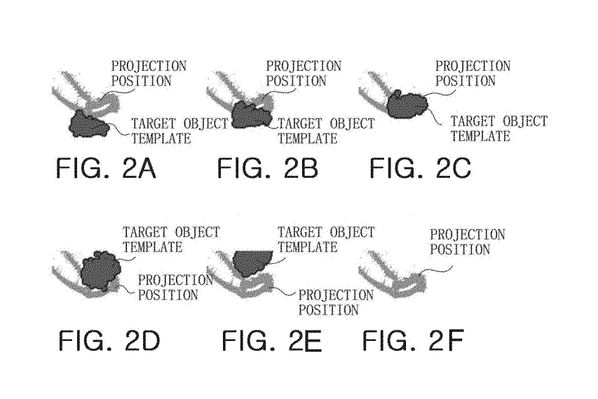

FIG. 2 is an example of determining a first target object template according to embodiments of the present invention. As shown in FIG. 2, the projection position may be obtained by projecting the events in the first event-stream segment to the imaging plane by time integral. Figures (A)-(F) of FIG. 2 show different overlaps of the pixel positions covered by the target object template of the key frame and its neighboring frames with the projection position. It can be seen that the target object template in (C) of FIG. 2 overlaps most of the projection position, thus the target object template may be determined as the first target object template. The target object template in (F) of FIG. 2 does not overlap with the projection position.

At block S105 of FIG. 1, a time alignment relation of an intermediate instant of the first event-stream segment and the timestamp of a frame corresponding to the first target object template may be used as a time alignment relation between the dynamic vision sensor and the assistant vision sensor. In other words, the method may determine that the intermediate instant of the first event-stream segment is temporally aligned with the timestamp of the frame of the first target object template that covers the most events in the first event-stream segment. The time alignment relation between the intermediate instant of the first event-stream segment and the timestamp of the frame corresponding to the first target object template may be used as a time alignment calibration between the dynamic vision sensor and the assistant vision sensor, to calibrate time difference between the dynamic vision sensor and the assistant vision sensor.

Here, the intermediate instant of the first event-stream segment may be an average of a start time point of the first event-stream segment (the timestamp of the start event of the first event-stream segment) and an end time point (the timestamp of the end event of the first event-stream segment).

It should be understood, at block S102, one or more key frames that reflect obvious movement of the target object may be determined from the video images. If this is determined at a plurality of key frames, blocks S103 and S104 may be performed for each key frame. Subsequently, at block S105, the time alignment relation between the dynamic vision sensor and the assistant vision sensor may be determined based on each time alignment relation between the intermediate instant of the first event-stream segment and the timestamp of the frame corresponding to the first target object template determined based on each key frame.

According to the time alignment calibration method described in embodiments of the present invention, since the dynamic vision sensor may be responsive to light changes only, a strong response may be produced to the event-stream segment in the vicinity of the timestamp of the key frame that reflects obvious movement of the target object. Events in this event-stream segment may be quite dense, thereby improving the accuracy of time alignment calibration.

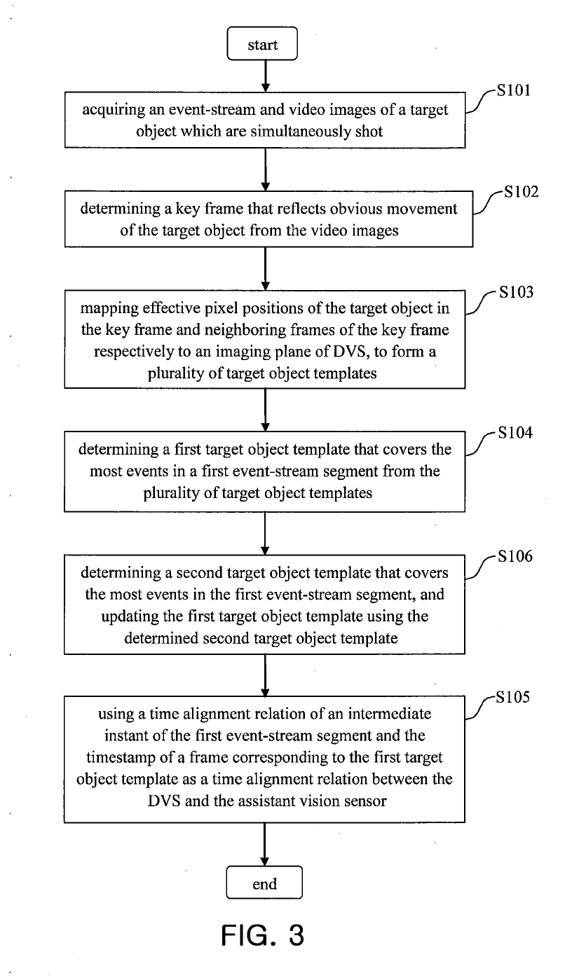

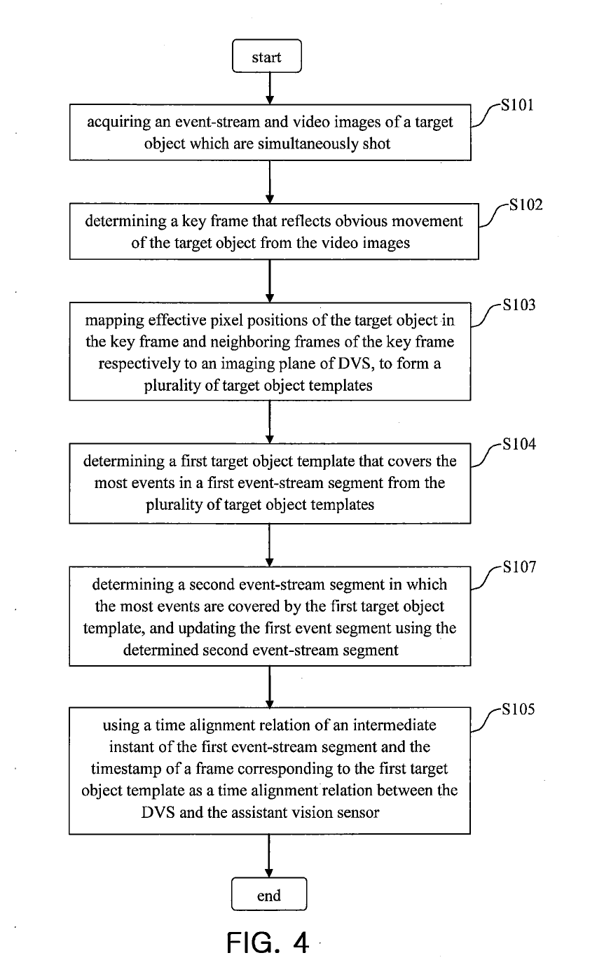

For example, a time precise alignment may be further performed after block S104 to improve accuracy of time alignment, thereby improving accuracy of time alignment calibration. The time alignment calibration method according to embodiments of the present invention will be illustrated by referring to FIGS. 3-4.

Referring to FIG. 3, the time alignment calibration method according to embodiments of the present invention also include block S106 in addition to blocks S101, S102, S103, S104 and S105 shown in FIG. 1. The blocks S101, S102, S103, S104, and S105 may be implemented according to the detailed description as discussed with respect to FIG. 1.

At a block S101, an event-stream and video images of a target object which are simultaneously shot by a dynamic vision sensor and an assistant vision sensor may be acquired.

At block S102, a key frame that reflects obvious movement of the target object may determined from the video images.

At block S103, effective pixel positions of the target object in the key frame and effective pixel positions of the target object in the neighboring frames of the key frame may be mapped to an imaging plane of the dynamic vision sensor, respectively, according to the spatial relative relation between the dynamic vision sensor and the assistant vision sensor, to form a plurality of target object templates.

At block S104, a first target object template that covers the most events in a first event-stream segment may determined from the plurality of target object templates.

At block S106, after determining the first target object template, target object templates, formed by mapping effective pixel positions of the target object in frames generated by the assistant vision sensor in time points adjacent to the timestamp of the frame corresponding to the first target object template to the imaging plane of the dynamic vision sensor according to the spatial relative relation between the dynamic vision sensor and the assistant vision sensor, are predicted. A second target object template that covers the most events in the first event-stream segment is determined from the predicted target object templates and the first target template, and the first target object template is updated using the determined second target object template. In other words, initially, the first target object template that is roughly aligned with the first event-stream segment in time domain may be determined. Then, a fine-tuning may be performed based on the first target object template to further determine the second target object template that is precisely aligned with the first event-stream segment.

As an example, the time points adjacent to the timestamp of the frame corresponding to the first target object template may include time points of predetermined time intervals between the timestamp of the frame corresponding to the first target object template and a timestamp of a previous frame, and/or time points of predetermined time intervals between the timestamp of the frame corresponding to the first target object template and a timestamp of a next frame.

As an example, the effective pixel positions of the target object templates in respective frames generated by the assistant vision sensor in time points adjacent to the timestamp of the frame corresponding to the first target object template based on the effective pixel positions of the target object in the frame corresponding to the first target object template and its adjacent frames may be determined. Then, the predicted effective pixel positions of the target object may be mapped to the imaging plane of the dynamic vision sensor to form respective target object templates. As another example, respective target object templates, formed by mapping the effective pixel positions of the target object in respective frames generated by the assistant vision sensor in the time points adjacent to the timestamp of the frame corresponding to the first target object template on the imaging plane of the dynamic vision sensor, may be directly predicted based on the first target object template and target object templates corresponding to the adjacent frames of the frame.

In some embodiments, the second target object template may be determined based on the first target object and the first event-stream segment by use of a temporal meanshift algorithm. Meanshift is a procedure for locating the maxima of a density function given discrete data sampled from that function. Meanshift may be useful for detecting the modes of this density. Meanshift is an iterative method, and usually starts with an initial estimate. Meanshift may be effective in cluster analysis for image processing.

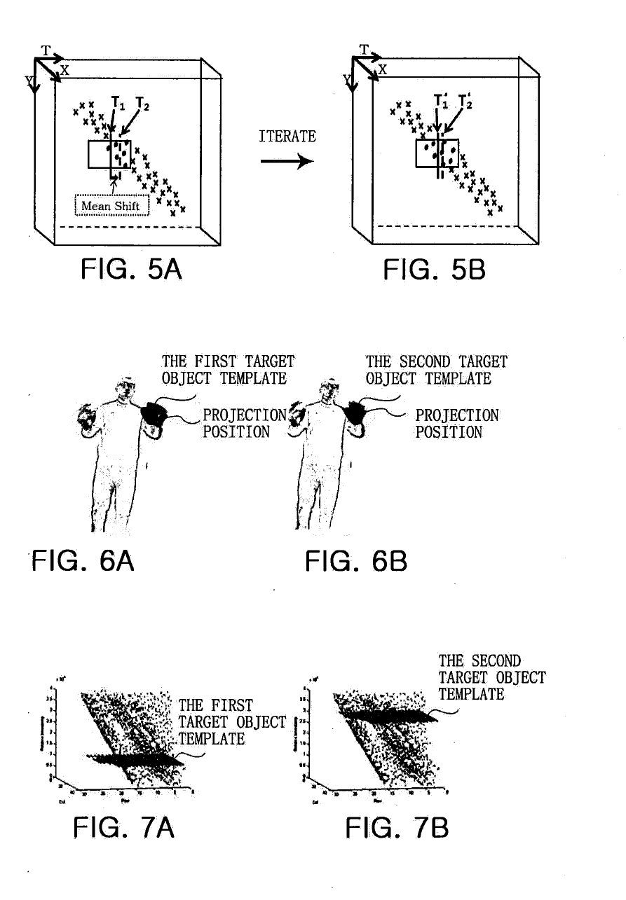

As shown in FIG. 5, the events in the first event-stream segment is shown by an image-time three-dimensional coordinate system. The points in the figure denote events, where T₁ is a timestamp of the frame corresponding to the target object template (the first target object template is initial), T₂ is an average of the timestamps of the events in the first event-stream segment covered by the target object template (the points in the solid frame in FIG. 5 denote the covered events), and a value of the timestamp Meanshift is T₁-T₂. In a second iteration, T₂ is assigned to T₁, such that T₁′=T₂, and T₂′ is an average of the timestamps of the events in the first event-stream segment coved by the target object template corresponding to the frame of which the timestamp is T₁′. Loop iterating may be performed until the timestamp Meanshift is 0, after which the iteration terminated. At this time, T₁ may be identified the timestamp of the frame corresponding to the second target object template.

FIGS. 6 and 7 show effects of covering events by the second target object template over the first target object template, according to embodiments of the present invention. As shown in FIG. 6, the projection position may be obtained by projecting the events in the first event-stream segment to the imaging plane by a time integral. If the target object is a hand, as in a view of (B) in FIG. 6, when compared with the first target object template shown in (A) of FIG. 6, the second target object show in (B) may overlap the projection position. (A) and (B) in FIG. 7 show different cases that the first and second target object templates cover the events in the first event-stream segment in the image-time coordinate system. It is observed that the second target object template may cover the events in the first event-stream segment.

At block S105, a time alignment relation of an intermediate instant of the first event-stream segment and the timestamp of a frame corresponding to the first target object template may be used as a time alignment relation between the dynamic vision sensor and the assistant vision sensor.

As shown in FIG. 4, the time alignment calibration method according to embodiments of the present invention also includes a block S107 in addition to blocks S101, S102, S103, S104 and S105 shown in FIG. 1. The blocks S101, S102, S103, S104, and S105 may be implemented according to the discussion related to the embodiment of FIG. 1.

At a block S101, an event-stream and video images of a target object, which are simultaneously shot by a dynamic vision sensor and an assistant vision sensor, may be acquired.

At block S102, a key frame that reflects obvious movement of the target object may be determined from the video images.

At block S103, effective pixel positions of the target object in the key frame and effective pixel positions of the target object in the neighboring frames of the key frame may be mapped to an imaging plane of the dynamic vision sensor, respectively, according to the spatial relative relation between the dynamic vision sensor and the assistant vision sensor, to form a plurality of target object templates.

At block S104, a first target object template that covers the most events in a first event-stream segment is determined from the plurality of target object templates.

At block S107, after determining the first target object template, a second event-stream segment in which the most events are covered by the first target object template may be determined from a plurality of event-stream segments having predetermined time lengths. Adjacent to the first event-stream segment, the first event-stream segment, and the first event segment may be updated using the determined second event-stream segment. In other words, initially, the first event-stream segment that is roughly aligned with the first target object template in time domain may be determined. Subsequently, a fine-tuning based on the first event-stream segment may be performed to further determine the second event-stream segment that is precisely aligned with the first target object template.

Here, the event-stream segment adjacent to the first event-stream segment may be an event-stream segment that partially overlaps the first event-stream segment as well as the event-stream segment in the vicinity of the first event-stream segment.

At block S105, a time alignment relation of an intermediate instant of the first event-stream segment and the timestamp of a frame corresponding to the first target object template may be used as a time alignment relation between the dynamic vision sensor and the assistant vision sensor.

The time alignment calibration method according to embodiments of the present invention shown in FIGS. 3 and 4 may further improve accuracy of the time alignment to reach temporal alignment in microseconds (i.e., temporal resolution of DVS), thereby meeting event level annotation.

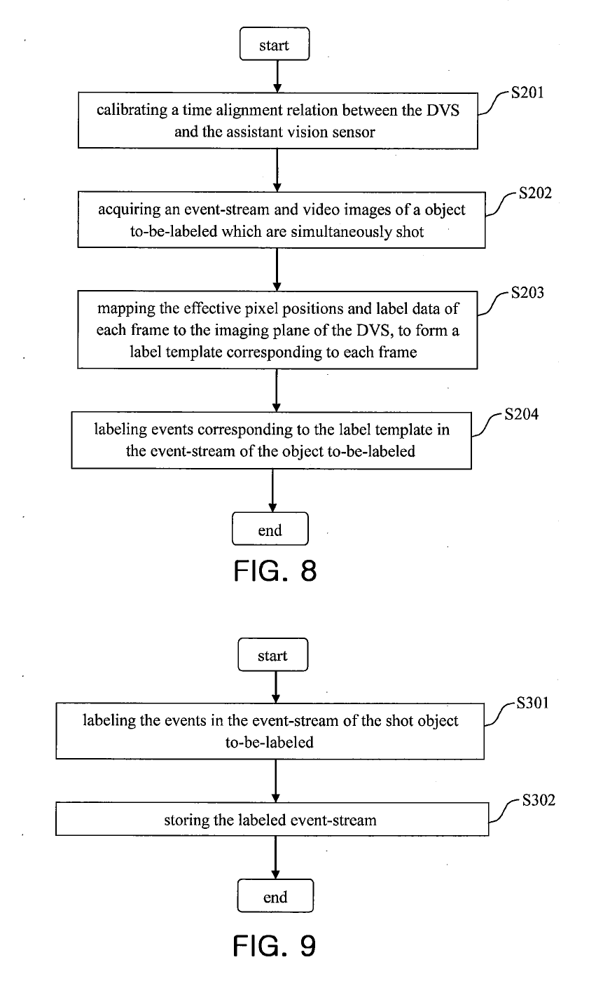

FIG. 8 is a flowchart of an event annotation method according to embodiments of the present invention. Referring to FIG. 8, at block S201, a time alignment relation between the dynamic vision sensor and the assistant vision sensor may be calibrated by the time alignment calibration method according to any one of the above embodiments.

At block S202, an event-stream and video images of a object to-be-labeled, which are simultaneously shot by the dynamic vision sensor and the assistant vision sensor, may be acquired. In some embodiments, the dynamic vision sensor and the assistant vision sensor may be calibrated identically as in block S201.

At block S203, for each frame of the video images of the object to-be-labeled, effective pixel positions of the object to-be-labeled and label data of each of the effective pixel positions may be acquired and mapped to an imaging plane of the dynamic vision sensor according to the spatial relative relation between the dynamic vision sensor and the assistant vision sensor, to form a label template corresponding to each frame.

As an example, the effective pixel positions of the object to-be-labeled may be pixel positions occupied by the object to-be-labeled in a frame. As an another example, the effective pixel positions of the object to-be-labeled may be pixel positions occupied by outwardly extending the pixel positions occupied by the object to-be-labeled in the frame by a predetermined range.

As an example, the label data of respective effective pixel positions of the object to-be-labeled may indicate that the effective pixel position correspond to the object to-be-labeled or a specific part of the object to-be-labeled. For instance, if the object to-be-labeled is a human body, the label data of a effective pixel position may indicate that the effective pixel position correspond to the human body or a specific part of the human body such as hand, head, etc.

As an example, the effective pixel positions of the object to-be-labeled in each frame may be detected by assorted proper algorithms. The effective pixel positions of the object to-be-labeled in respective frames and the label data of the respective effective pixel positions may be acquired from the assistant vision sensor (i.e., the assistant vision sensor may detect the effective pixel positions of the object to-be-labeled in respective frames). For example, when the assistant vision sensor is a depth vision sensor, the assistant vision sensor may detect the effective pixel positions of the hand (the object to-be-labeled) in the image according to the shot depth images and skeleton data of the human body. The assistant vision sensor may assign label data to respective effective pixel positions, to indicate that respective effective pixel positions correspond to hand.

In addition, as an example, label templates, formed by mapping the effective pixel positions of the object to-be-labeled in frames generated by the assistant vision sensor in each time point between each two adjacent frames of the video images and the label data of each of the effective pixel positions to the imaging plane of the dynamic vision sensor according to the spatial relative relation between the dynamic vision sensor and the assistant vision sensor, may also be predicted. Here, the time points between the timestamps of each two adjacent frames may be respective time points of time intervals separating timestamps of each two adjacent frames.

At block S204, the events corresponding to the label template, in the event-stream of the object to-be-labeled, are labeled according to the corresponding label template. An event corresponding to the label template may be the event of which a timestamp is overlapped by a time period of a label template, and/or a pixel position is overlapped by the label template. The time period of the label template may be a time period in the vicinity of a time point where the timestamp of the frame corresponding to the label template may be aligned according to the time alignment relation between the dynamic vision sensor and the assistant vision sensor.

As an example, the time period of the label template may be a time period having a predetermined time length and using the time point where the timestamps of the frame corresponding to the label template is aligned according to the time alignment relation between the dynamic vision sensor and the assistant vision sensor as the intermediate instant. Here, the predetermined time length and the predetermined time length in the time alignment calibration method according to the embodiments illustrated in FIGS. 1, 3 and 4 may be identical.

Specifically, each event may map with a pixel position on the imaging plane of the dynamic vision sensor, and the pixel positions in the imaging plane covered by each label template may include pixel positions corresponding to the effective pixel positions in the corresponding frame, generated by mapping the effective pixel positions to the imaging plane of the dynamic vision sensor, such that the events of which the pixel positions are coved by the label template may be determined.

In addition, as an example, when the predetermined time length is shorter than the time interval between the adjacent frames of the video images, such that the event within the timestamp is not overlapped by the time period of any label templates in the event-stream of the object to-be-labeled, a temporal nearest neighbor algorithm may be used to determine the corresponding label template. The events may be labeled according to the corresponding label template.

As an example, labeling an event according to the label template may include labeling the event according to the label data of the pixel position, which is the same in the label template for the event. For example, the event may be labeled directly by the label data of the pixel position that is the same in the corresponding label template and the event.

As an example, in the above embodiment, the target object may be the object to-be-labeled itself. That is, the time alignment calibration between the dynamic vision sensor and the assistant vision sensor may be performed based on the object to-be-labeled first, and then event annotation may be performed directly based on the object to-be-labeled. Also, the time alignment calibration between the dynamic vision sensor and the assistant vision sensor may be performed based on the target object first, and then the event annotation is performed based on the object to-be-labeled.

By the event annotation method according to embodiments of the present invention, labeling of an event automatically may be realized faster and may have a higher accuracy than existing event annotation schemes.

FIG. 9 is a flowchart of a database generation method according to embodiments of the present invention.

Referring to FIG. 9, at block S301, the event annotation method in any one of the above embodiments may be employed to label events in the event-stream of the shot object to-be-labeled. At block S302, the labeled event-stream may be stored to form a database for serving to the dynamic vision sensor.

As an example, the object to-be-labeled may be shot by using a plurality of dynamic vision sensor and an assistant vision sensor simultaneously, to form the database for serving the dynamic vision sensor quickly and effectively. Specifically, lenses of different dynamic vision sensors may be adhered with different light attenuators to simulate event-streams of object to-be-labeled shot in different illuminating environments. Blocks S301 and S302 may then be performed to each dynamic vision sensor and the assistant vision sensor. In addition, the object to-be-labeled may also be shot using a plurality of dynamic vision sensors and a plurality of assistant vision sensors simultaneously, or using a dynamic vision sensor and a plurality of assistant vision sensors simultaneously, to form the database serving the dynamic vision sensor fast and effectively.

Database generation may include, according to embodiments of the present invention, combining the DVS and the existing mature vision sensor. In this manner, an event-stream database for serving DVS can be generated quickly and precisely by automatic temporal alignment and automatic event annotation.

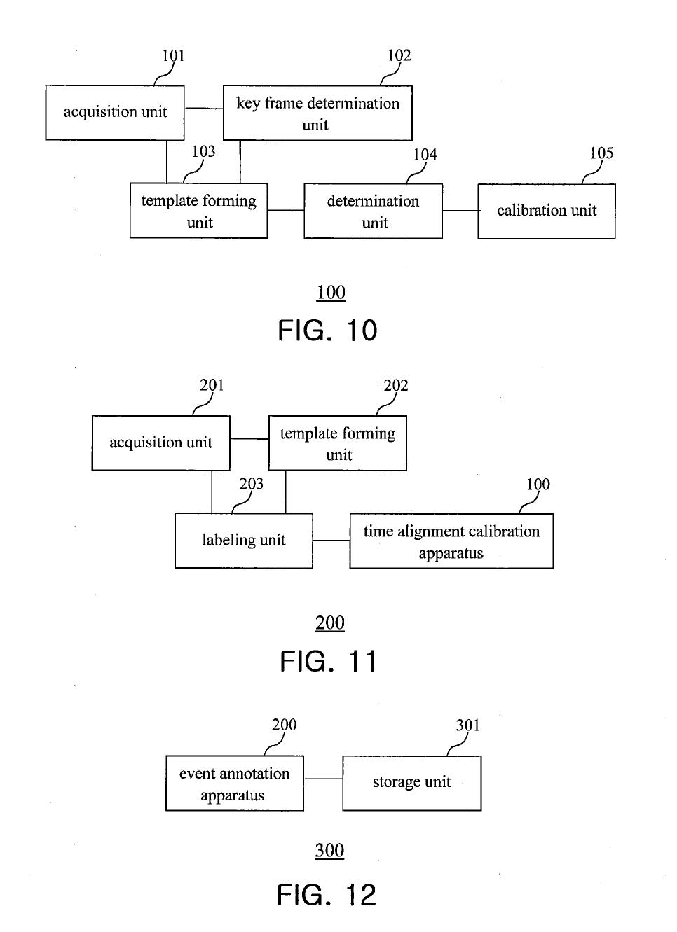

FIG. 10 is a flowchart of a time alignment calibration apparatus according to embodiments of the present invention. As shown in FIG. 10, a time alignment calibration apparatus 100 according to embodiments of the present invention may include an acquisition unit 101, a key frame determination unit 102, a template forming unit 103, a determination unit 104, and a calibration unit 105.

The acquisition unit 101 serves to acquire an event-stream and video images of a target object which are simultaneously shot by a dynamic vision sensor and an assistant vision sensor, respectively. As an example, the assistant vision sensor may be a depth vision sensor, and the video images may be depth images. A lens of the dynamic vision sensor may be associated with a filter to remove influence on shooting of the dynamic vision sensor when shooting the target object with the assistant vision sensor simultaneously.

As an example, the acquisition unit 101 may also filter the acquired event stream using a filter to remove influence on shooting of the dynamic vision sensor when shooting the target object with the assistant vision sensor simultaneously.

The key frame determination unit 102 serves to determine a key frame that reflects obvious movement of the target object from the video images.

The template forming unit 103 serves to provide effective pixel positions of the target object in the key frame and effective pixel positions of the target object in the neighboring frames of the key frame, respectively, to an imaging plane of the dynamic vision sensor according to a spatial relative relation between the dynamic vision sensor and the assistant vision sensor, to form a plurality of target object templates.

As an example, the effective pixel positions of the target object may be pixel positions occupied by the target object in a frame, or pixel positions occupied by outwardly extending the pixel positions occupied by the target object in the frame by a predetermined range.

As an example, the spatial relative relation between the dynamic vision sensor and the assistant vision sensor may be calibrated according to intrinsic and extrinsic parameters of the dynamic vision sensor as well as intrinsic and extrinsic parameters of the assistant vision sensor.

The determination unit 104 serves to determine a first target object template that covers most events in a first event-stream segment from the plurality of target object templates. The first event-stream segment is an event-stream segment having a predetermined time length in the vicinity of the timestamp of the key frame in the event-stream and mapped along time axis. As an example, the predetermined time length may be less than or equal to the time intervals between adjacent frames of the video images.

The time alignment calibration apparatus 100 according to embodiments of the present invention may also include an event-stream segment acquisition unit (not shown) that serves to map, along the time axis, an event-stream segment having a predetermined time length and uses the timestamp of the key frame as the intermediate instant in the event-stream, as the first event-stream segment, or to determine a shooting time point of alignment of the dynamic vision sensor and the timestamp of the key frame according to an initial time alignment relation between the dynamic vision sensor and the assistant vision sensor. The time alignment calibration apparatus 100 may map, along the time axis, an event-stream segment having predetermined time length, by taking the shooting time point of the alignment as the intermediate instant in the event-stream, as the first event-stream segment.

As an example, the determination unit 104 may determine a number of events in the first event-stream segment corresponding to the pixel positions covered by each of the plurality of target object templates in the imaging plane, and determine a target object template corresponding to the largest number of events as the first target object template.

As an another example, the determination unit 104 may project the events in the first event-stream segment to the imaging plane by time integral to obtain a projection position. The determination unit 104 may determines pixel positions, covered by each of the plurality of target object templates, in the imaging plane, and determine a target object template of which the covered pixel positions overlaps most of the projection position, as the first target object template.

The calibration unit 105 serves to use a time alignment relation of an intermediate instant of the first event-stream segment and the timestamp of a frame corresponding to the first target object template as a time alignment relation between the dynamic vision sensor and the assistant vision sensor.

As an example, the determination unit 104 may also, after determining the first target object template, predict target object templates formed by mapping effective pixel positions of the target object in frames generated by the assistant vision sensor in time points adjacent to the timestamp of the frame corresponding to the first target object template to the imaging plane of the dynamic vision sensor according to the spatial relative relation between the dynamic vision sensor and the assistant vision sensor. The determination unit 104 may determine, a second target object template that covers most events in the first event-stream segment from predicted target object templates and the first target template, and may update the first target object template using the determined second target object template.

As an example, the time points adjacent to the timestamp of the frame corresponding to the first target object template may include time points of predetermined time intervals between the timestamp of the frame corresponding to the first target object template and a timestamp of a previous frame, and/or time points of predetermined time intervals between the timestamp of the frame corresponding to the first target object template and a timestamp of a next frame.

As an example, determination unit 104 may determine the second target object template based on the first target object and the first event-stream segment by means of a temporal meanshift algorithm.

As an another example, the determination unit 104 may also, after determining the first target object template, determine a second event-stream segment in which most events are covered by the first target object template from a plurality of event-stream segments having predetermined time length and that are adjacent to the first event-stream segment. The determination unit 104 may update the first event segment using the determined second event-stream segment.

The detail implementation of the time alignment calibration apparatus 100 according to embodiments of the present invention may be realized by referring to the related detailed embodiments illustrated in FIGS. 1-7.

FIG. 11 is a flowchart of an event annotation apparatus according to embodiments of the present invention. As shown in FIG. 11, an event annotation apparatus 200, according to embodiments of the present invention, includes a time alignment calibration apparatus 100, an acquisition unit 201, a template forming unit 202 and a labeling unit 203.

The time alignment calibration apparatus 100 serves to calibrate a time alignment relation between the dynamic vision sensor and the assistant vision sensor. The acquisition unit 201 serves to acquire an event-stream and video images of a object to-be-labeled which are simultaneously shot by the dynamic vision sensor and the assistant vision sensor, respectively. The template forming unit 202 serves to acquire effective pixel positions of the object to-be-labeled and label data of each of the effective pixel positions, for each frame of the video images of the object to-be-labeled, and map the effective pixel positions and label data to the imaging plane of the dynamic vision sensor according to the spatial relative relation between the dynamic vision sensor and the assistant vision sensor, to form a label template corresponding to each frame.

As an example, the template forming unit 202 may also predict label templates formed by mapping the effective pixel positions of the object to-be-labeled in frames generated by the assistant vision sensor in each time point between each of two adjacent frames of the video images and the label data of the effective pixel positions to the imaging plane of the dynamic vision sensor according to the spatial relative relation between the dynamic vision sensor and the assistant vision sensor.

The labeling unit 203 serves to label events corresponding to the label template in the event-stream of the object to-be-labeled, according to the corresponding label template, wherein an event corresponding to the label template is the event of which a timestamp is overlapped by a time period of a label template, and a pixel position is overlapped by the label template. The time period of the label template may be a time period in the vicinity of a time point where the timestamp of the frame corresponding to the label template aligned according to the time alignment relation between the dynamic vision sensor and the assistant vision sensor.

As an example, the time period of the label template may be a time period having a predetermined time length and using the time point where the timestamps of the frame corresponding to the label template is aligned according to the time alignment relation between the dynamic vision sensor and the assistant vision sensor as the intermediate instant.

As an example, when the predetermined time length is shorter than the time interval between the adjacent frames of the video images, with regard to the event of which the timestamp is not overlapped by the time period of any label templates in the event-stream of the object to-be-labeled, the labeling unit 203 may use a temporal nearest neighbor algorithm to determine the corresponding label template, and labels the event according to the corresponding label template.

As an example, the labeling unit 203 may label an event according to the label data having the same pixel position with the event in the label template. It should be understood that the detailed implementation of the event annotation apparatus 200 according to embodiments of the present invention may be realized by referring to the related embodiments illustrated in FIG. 8.

FIG. 12 is a flowchart of a database generation apparatus according to embodiments of the present invention. As shown in FIG. 12, a database generation apparatus 300 includes an event annotation apparatus 200 and a storage unit 301. The event annotation apparatus 200 serves to label the events in the event-stream of the shot object to-be-labeled. The storage unit 301 serves to store the labeled event-stream to form a database for serving the dynamic vision sensor.

The detailed implementation of the database generation apparatus 300 according to embodiments of the present invention may be realized by referring to the related embodiment illustrated in FIG. 9.

The method and system for time alignment calibration, event annotation and database generation according to the embodiments of the present invention may implement time alignment calibration between a dynamic vision sensor and a vision sensor based on an image frame, labeling events in an event-stream output by the dynamic vision sensor, and/or generating a database serving for the dynamic vision sensor.

According to some embodiments, operating Dynamic Vision Sensors (DVS) in a multi-view video system, may include acquiring a first video event-stream of a target object from a dynamic vision sensor and acquiring a second video event-stream of the target object from an assistant vision sensor. Movement of the target object in a key frame of the first video event-stream of the target object from the dynamic vision sensor may be recognized. A synchronized frame from the assistant vision sensor may be determined based on a mapping of effective pixel positions of the target object in the key frame to pixel positions in one or more frames in the second video event-stream of the target object from an assistant vision sensor. Labeling of a DVS image sequence may be generated based on interpolating frames associated with the synchronized frame between the first video event-stream from the dynamic vision sensor and the second video event-stream from the assistant vision sensor based on the synchronized frame.

In some embodiments, determining the synchronized frame from the assistant vision sensor may include performing a temporal adjustment to compensate for communication delay between the first video event-stream from the dynamic vision sensor and the second video event-stream from the assistant vision sensor based on identifying a first movement of the target object in the first video event-stream from the dynamic vision sensor that corresponds to a second movement of the target object in the second video event-stream from the assistant vision sensor.

In some embodiments, determining the synchronized frame may include identifying the target object in a plurality of frames in the second video event-stream from the assistant vision sensor, generating a density function of a plurality of pixel locations of the target object corresponding to the plurality of frames in the second video event-stream from the assistant vision sensor, applying a meanshift to locate a cluster in the density function, and identifying the synchronized frame in the second video event-stream from the assistant vision sensor based on the meanshift.

The position of the target object in the key frame may be offset from a position of the target object in a neighboring frame that neighbors the key frame. Recognizing movement of the target object in the key frame may correspond to gestures in a multi-view video stream recorded by the dynamic vision sensor and the assistant vision sensor.

In addition, the respective modules in the time alignment calibration apparatus, the event annotation apparatus and the database generation apparatus according to the embodiments of the present invention may be implemented as hardware components or software components. Those skilled in the art may implement respective units by using, for example, field-programmable gate array (FPGA) or application-specific integrated circuit (ASIC), according to the processes performed by respective defined units.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

In addition, the time alignment calibration apparatus, the event annotation apparatus and the database generation apparatus according to the embodiments of the present invention may also be embodied as computer readable codes on a computer readable recording medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. Those skilled in the art may implement the computer codes according to the description for the above method. The above method is implemented while the computer code is executed on a processor of a computer.

Although the application has illustrated and described some example embodiments, it will be understood by those skilled in the art that amendments may be made to the described embodiments without departing from the spirit and scope defined by the claims and its equivalents.

1. A time alignment calibration method comprising:
acquiring an event-stream and video images of a target object which are simultaneously shot by a dynamic vision sensor and an assistant vision sensor, respectively;
determining a key frame that reflects obvious movement of the target object from the video images;
mapping effective pixel positions of the target object in the key frame and effective pixel positions of the target object in neighboring frames of the key frame respectively to an imaging plane of the dynamic vision sensor according to a spatial relative relation between the dynamic vision sensor and the assistant vision sensor, to form a plurality of target object templates;
determining a first target object template that covers events in a first event-stream segment from the plurality of target object templates, wherein the first event-stream segment has a predetermined time length in a vicinity of a timestamp of the key frame in the event-stream and mapped along a time axis; and
using a time alignment relation of an intermediate instant of the first event-stream segment and a timestamp of a frame corresponding to the first target object template as a time alignment relation between the dynamic vision sensor and the assistant vision sensor.

2. The method of claim 1, further comprising:
after determining the first target object template, predicting target object templates formed by mapping effective pixel positions of the target object in frames generated by the assistant vision sensor in time points adjacent to the timestamp of the frame corresponding to the first target object template to the imaging plane of the dynamic vision sensor according to the spatial relative relation between the dynamic vision sensor and the assistant vision sensor, determining a second target object template that covers events in the first event-stream segment from target object templates that were predicted and the first target object template, and updating the first target object template using the determined second target object template;
or
after determining the first target object template, determining a second event-stream segment in which events are covered by the first target object template from a plurality of event-stream segments having predetermined time length and adjacent to the first event-stream segment and the first event-stream segment, and updating the first event-stream segment using the determined second event-stream segment.

3. The method of claim 2, wherein the time points adjacent to the timestamp of the frame corresponding to the first target object template comprises time points of predetermined time intervals between the timestamp of the frame corresponding to the first target object template and a timestamp of a previous frame, and/or time points of predetermined time intervals between the timestamp of the frame corresponding to the first target object template and a timestamp of a next frame.

4. The method of claim 2, wherein after determining the first target object template, the second target object template is determined based on the first target object template and the first event-stream segment based on a temporal meanshift algorithm.

5. The method of claim 1, wherein the predetermined time length is less than or equal to the time intervals between adjacent frames of the video images, and the time alignment calibration method further comprises:
mapping, along the time axis, an event-stream segment having a predetermined time length and using the timestamp of the key frame as the intermediate instant in the event-stream, as the first event-stream segment;
or
determining a shooting time point of alignment of the dynamic vision sensor and the timestamp of the key frame according to an initial time alignment relation between the dynamic vision sensor and the assistant vision sensor, and mapping, along the time axis, an event-stream segment having predetermined time length and using the shooting time point of the alignment as the intermediate instant in the event-stream, as the first event-stream segment.

6. The method of claim 1, wherein the effective pixel positions of the target object are pixel positions occupied by the target object in a frame, or pixel positions occupied by outwardly extending the pixel positions occupied by the target object in the frame by a predetermined range.

7. The method of claim 1, wherein the determining the first target object template that covers events in the first event-stream segment comprises:
determining a number of events in the first event-stream segment corresponding to pixel positions covered by each of the plurality of target object templates in the imaging plane, and determining a target object template corresponding to a largest number of events as the first target object template;
or
projecting the events in the first event-stream segment to the imaging plane by time integral to obtain projection position, determining pixel positions, covered by each of the plurality of target object templates, in the imaging plane, and determining a target object template of which the covered pixel positions overlap the most projection position, as the first target object template.

8. The method of claim 1, wherein the assistant vision sensor is a depth vision sensor, and the video images are depth images.

9. The method of claim 1, wherein a lens of the dynamic vision sensor is associated with a filter to remove influence on shooting of the dynamic vision sensor when shooting the target object with the assistant vision sensor simultaneously.

10. The method of claim 1, wherein the spatial relative relation between the dynamic vision sensor and the assistant vision sensor is calibrated according to intrinsic and/or extrinsic parameters of the dynamic vision sensor as well as intrinsic and/or extrinsic parameters of the assistant vision sensor.

11. The method of claim 1, further comprising:
acquiring an event-stream and video images of a object to-be-labeled which are simultaneously shot by the dynamic vision sensor and the assistant vision sensor, respectively;
acquiring effective pixel positions of the object to-be-labeled and label data of each of the effective pixel positions, for each frame of the video images of the object to-be-labeled, and mapping the effective pixel positions and label data to the imaging plane of the dynamic vision sensor according to the spatial relative relation between the dynamic vision sensor and the assistant vision sensor, to form a label template corresponding to each frame; and
labeling events corresponding to the label template in the event-stream of the object to-be-labeled, according to the corresponding label template, wherein an event corresponding to the label template is the event of which a timestamp is overlapped by a time period of a label template, and a pixel position is overlapped by the label template, wherein the time period of the label template is a time period in a vicinity of a time point where the timestamp of the frame corresponding to the label template aligned according to the time alignment relation between the dynamic vision sensor and the assistant vision sensor.

12. The method of claim 11, wherein the time period of the label template is a time period having a predetermined time length and using the time point where the timestamps of the frame corresponding to the label template is aligned according to the time alignment relation between the dynamic vision sensor and the assistant vision sensor as the intermediate instant.

13. The method of claim 12, wherein when the predetermined time length is shorter than the time interval between adjacent frames of the video images, the labeling events corresponding to the label template further comprises: with regard to the event of which the timestamp is not overlapped by the time period of label templates in the event-stream of the object to-be-labeled, using a temporal nearest neighbor algorithm to determine the corresponding label template, and labeling the event according to the corresponding label template.

14. The method of claim 11, wherein the acquiring effective pixel positions further comprises:
predicting label templates formed by mapping the effective pixel positions of the object to-be-labeled in frames generated by the assistant vision sensor in each time point between each two adjacent frames of the video images and the label data of the effective pixel positions to the imaging plane of the dynamic vision sensor according to the spatial relative relation between the dynamic vision sensor and the assistant vision sensor.

15. A time alignment calibration apparatus, comprising:
an acquisition unit to acquire an event-stream and video images of a target object which are simultaneously shot by a dynamic vision sensor and an assistant vision sensor, respectively;
a key frame determination unit to determine a key frame that reflects obvious movement of the target object from the video images;
a template forming unit to map effective pixel positions of the target object in the key frame and effective pixel positions of the target object in neighboring frames of the key frame respectively to an imaging plane of the dynamic vision sensor according to a spatial relative relation between the dynamic vision sensor and the assistant vision sensor, to form a plurality of target object templates;
a determination unit to determine a first target object template that covers events in a first event-stream segment from the plurality of target object templates, wherein the first event-stream segment has a predetermined time length in a vicinity of a timestamp of the key frame in the event-stream and mapped along time axis; and
a calibration unit to use a time alignment relation of an intermediate instant of the first event-stream segment and a timestamp of a frame corresponding to the first target object template as a time alignment relation between the dynamic vision sensor and the assistant vision sensor.

16. A method of operating Dynamic Vision Sensors (DVS) in a multi-view video system, the method comprising:
acquiring a first video event-stream of a target object from a dynamic vision sensor;
acquiring a second video event-stream of the target object from an assistant vision sensor;
recognizing movement of the target object in a key frame of the first video event-stream of the target object from the dynamic vision sensor;
determining a synchronized frame based on performing a temporal adjustment to compensate for communication delay between the first video event-stream from the dynamic vision sensor and the second video event-stream from the assistant vision sensor based on identifying a first movement of the target object in the first video event-stream from the dynamic vision sensor that corresponds to a second movement of the target object in the second video event-stream from the assistant vision sensor; and
generating labeling of a DVS image sequence based on interpolating frames associated with the synchronized frame between the first video event-stream from the dynamic vision sensor and the second video event-stream from the assistant vision sensor based on the synchronized frame.

17. (canceled)

18. The method of claim 16, wherein the determining the synchronized frame comprises:
identifying the target object in a plurality of frames in the second video event-stream from the assistant vision sensor;
generating a density function of a plurality of pixel locations of the target object corresponding to the plurality of frames in the second video event-stream from the assistant vision sensor;
applying a meanshift to locate a cluster in the density function; and
identifying the synchronized frame in the second video event-stream from the assistant vision sensor based on the meanshift.

19. The method of claim 16, wherein a position of the target object in the key frame is offset from a position of the target object in a neighboring frame that neighbors the key frame.

20. The method of claim 16, wherein the recognizing movement of the target object in the key frame corresponds to gestures in a multi-view video stream recorded by the dynamic vision sensor and the assistant vision sensor.
